(19) United States
(12) Patent Application Publication
(10) Pub. No.: US 2007/0008443 A1
(43) Pub. Date: Jan. 11, 2007

(54) Display substrate, method of manufacturing the same and display apparatus having the same

(75) Inventors: Jong-Hyun Seo, Seoul (KR); Mun-Pyo Hong, Seongnam-si (KR); Joon-Hak Oh, Seoul (KR)

Correspondence Address: MACPHERSON KWOK CHEN & HEID LLP, 2033 GATEWAY PLACE, SUITE 400, SAN JOSE, CA, 95110, US

(73) Assignee: SAMSUNG ELECTRONICS CO., LTD, Suwon-si (KR)

(21) Appl. No.: 11/281,998

(22) Filed: Nov. 16, 2005

(30) Foreign Application Priority Data
Jul. 5, 2005 (KR) 2005-60080

(51) Int. Cl. G02F 1/136

(52) U.S. Cl. 349/43

(57) ABSTRACT

A display substrate includes a plastic substrate, a gate wiring, a gate insulation layer, first and second active layers, a data wiring and a drain wiring. The gate wiring includes a gate line, a first gate electrode portion and a second gate electrode portion. The first and second active layers are formed on first and second portions of the gate insulation layer. The data wiring includes a first data line having first and second source electrode portions formed on the first and second active layers, respectively. The drain wiring is disposed between the first data line and the second data line. The drain wiring includes first and second drain electrode portions formed on the first and second active layers, respectively. Therefore, even if the display substrate contracts, resulting in a misalignment of the active layers and the source and drain wirings, one of the two thin film transistors continues to operate normally.

### CROSS REFERENCE TO RELATED APPLICATIONS

This application relies for priority upon Korean Patent Application No. 2005-60080 filed on Jul. 5, 2005, the contents of which are herein incorporated by reference in its entirety.

### BACKGROUND

1. Field of the Invention

The present invention relates to a display substrate, a method of manufacturing the display substrate and a display apparatus having the display substrate. More particularly, the present invention relates to a display substrate capable of reducing defects caused by misalignment, a method of manufacturing the display substrate and a display apparatus having the display substrate.

2. Description of the Related Art

Many electric devices, such as mobile phones, digital cameras, notebook computers, monitors, etc. employ a display apparatus. Examples of the display apparatus include a liquid crystal display (LCD) apparatus, an organic light emitting (OLED) device, etc.

The LCD apparatus and the OLED apparatus include a display substrate for independently driving each pixel. The display substrate includes an insulation substrate with signal wirings and a driving device such as a thin film transistor (TFT) formed on the insulation substrate.

A glass substrate has been employed as a conventional insulation substrate. However, a flexible plastic substrate may be employed as the insulation substrate in order to reduce weight and thickness thereof.

When a plastic substrate is employed as the insulation substrate, the plastic substrate may be deformed during a process of forming the signal wirings and the TFT, which induces a misalignment. When a size of the plastic substrate increases, the misalignment becomes severe at edge regions of the plastic substrate. In particular, when the plastic substrate contracts after an etching process of an active layer of the TFT, the source electrode and the drain electrode no longer overlap with the active layer, thereby inducing a ‘channel open’ condition, so that the display substrate is not driven.

### SUMMARY

In accordance with the present invention, a display substrate capable of reducing defects caused by misalignment is provided.

In accordance with the present invention, a method of manufacturing the above display substrate is also provided.

In accordance with the present invention, a display apparatus having the display substrate is also provided.

In an exemplary display substrate according to the present invention, the display substrate includes a plastic substrate, a gate wiring, a gate insulation layer, first and second active layers, a data wiring and a drain wiring. The gate wiring is formed on the plastic substrate along a first direction. The gate wiring includes a gate line, a first gate electrode portion, and a second gate electrode portion. The gate insulation layer is formed on the plastic substrate having the gate wiring formed thereon. The first and second active layers are formed on first and second portions of the gate insulation layer. The first and second portions of the insulation layer correspond to the first and second gate electrode portions, respectively. The data wiring is formed on the gate insulation layer along a second direction that is nonparallel with the first direction. The data wiring includes a first data line having a first source electrode portion formed on the first active layer, and a second data line having a second source electrode portion formed on the second active layer. The drain wiring is disposed between the first data line and the second data line. The drain wiring includes a first drain electrode portion formed on the first active layer, and a second drain wiring including a second drain electrode portion formed on the second active layer.

Preferably, the first active layer is formed such that a distance between a center of the first active layer and the first source electrode portion is less than a distance between the center of the first active layer and the first drain electrode portion.

Additionally, the second active layer is formed such that a distance between a center of the second active layer and the second source electrode portion is less than a distance between the center of the second active layer and the second drain electrode portion.

In an exemplary method of manufacturing a display substrate according to the present invention, a gate wiring is formed on a plastic substrate. The gate wiring includes a gate line, a first gate electrode portion and a second electrode portion. A gate insulation layer is formed on the plastic substrate having the gate wiring formed thereon. First and second active layers are formed on first and second portions of the gate insulation layer. The first and second portions of the insulation layer correspond to the first and second gate electrode portions, respectively. A data wiring is formed on the gate insulation layer along a second direction that crosses the first direction. The data wiring includes a first data line having a first source electrode portion formed on the first active layer, and a second data line having a second source electrode portion formed on the second active layer. A drain wiring is formed between the first data line and the second data line. The drain wiring includes a first drain electrode portion formed on the first active layer, and a second drain wiring including a second drain electrode portion formed on the second active layer.

Preferably, the first active layer is formed such that a distance between a center of the first active layer and the first source electrode portion is less than a distance between the center of the first active layer and the first drain electrode portion, and the second active layer is formed such that a distance between a center of the second active layer and the second source electrode portion is less than a distance between the center of the second active layer and the second drain electrode portion.

In an exemplary display apparatus according to the present invention, the display apparatus includes a first substrate, a second substrate facing the first substrate, and a liquid crystal layer disposed between the first and second substrates.

The first substrate includes a first plastic substrate, a gate wiring, a gate insulation layer, first and second active layers, a data wiring, and a drain wiring. The gate wiring is formed on the first plastic substrate along a first direction. The gate wiring includes a gate line, a first gate electrode portion, and a second gate electrode portion. The gate insulation layer is formed on the plastic substrate having the gate wiring formed thereon. The first and second active layers are formed on first and second portions of the gate insulation layer. The first and second portions of the insulation layer correspond to the first and second gate electrode portions, respectively. The data wiring is formed on the gate insulation layer along a second direction nonparallel with the first direction. The data wiring includes a first data line having a first source electrode portion formed on the first active layer, and a second data line having a second source electrode portion formed on the second active layer. The drain wiring is disposed between the first data line and the second data line. The drain wiring includes a first drain electrode portion formed on the first active layer, and a second drain wiring including a second drain electrode portion formed on the second active layer.

Preferably, the first active layer is formed such that a distance between a center of the first active layer and the first source electrode portion is less than a distance between the center of the first active layer and the first drain electrode portion, and the second active layer is formed such that a distance between a center of the second active layer and the second source electrode portion is less than a distance between the center of the second active layer and the second drain electrode portion.

Therefore, even if the display substrate contracts, resulting in a misalignment of the active layers and the source and drain wirings, one of the two switching devices continues to operate normally.

### BRIEF DESCRIPTION OF THE DRAWINGS

The above and other features and advantages of the present invention will become more apparent by describing in detail exemplary embodiments thereof with reference to the accompanying drawings, in which:

FIG. 1 is a layout illustrating a portion of a display substrate according to an exemplary embodiment of the present invention;

FIG. 2 is a cross-sectional view taken along a line I-I′ in FIG. 1;

FIG. 3 is a layout illustrating a portion of a display substrate that is contracted;

FIG. 4 is a cross-sectional view illustrating the plastic substrate in FIG. 2;

FIGS. 5 through 8 are cross-sectional views illustrating a method of manufacturing the display substrate in FIGS. 1 and 2; and

FIG. 9 is a cross-sectional view illustrating a display apparatus according to an exemplary embodiment of the present invention.

### DESCRIPTION OF THE EMBODIMENTS

It should be understood that the exemplary embodiments of the present invention described below may be varied or modified in many different ways without departing from the inventive principles disclosed herein, and the scope of the present invention is therefore not limited to these particular embodiments. Rather, these embodiments are provided so that this disclosure will be thorough and complete, and will fully convey the concept of the invention to those skilled in the art by way of example and not of limitation.

Hereinafter, the embodiments of the present invention will be described in detail with reference to the accompanied drawings.

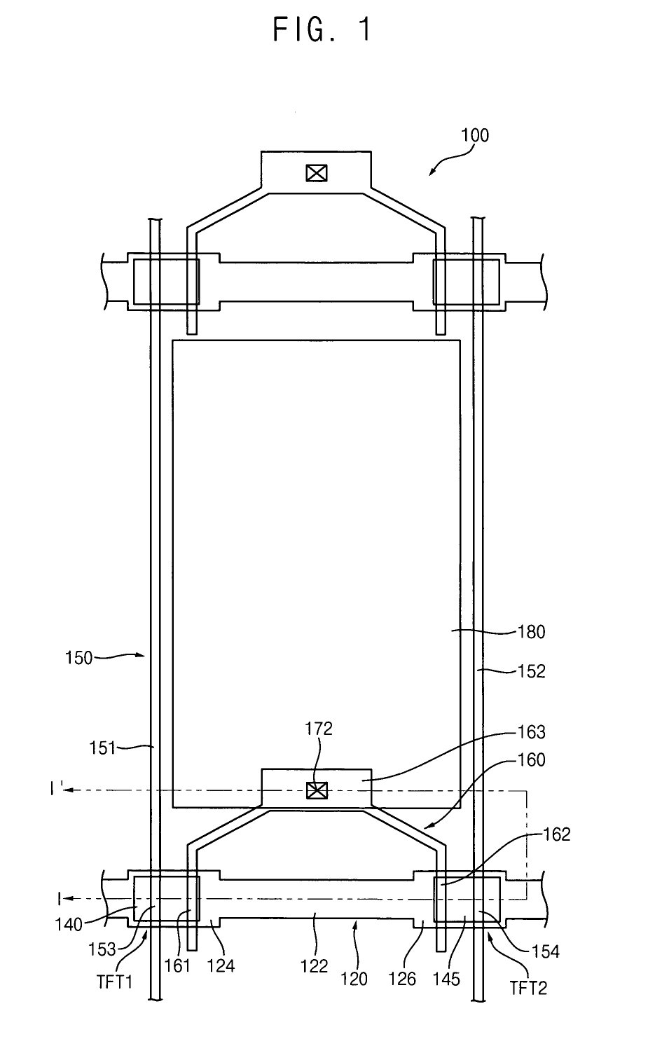

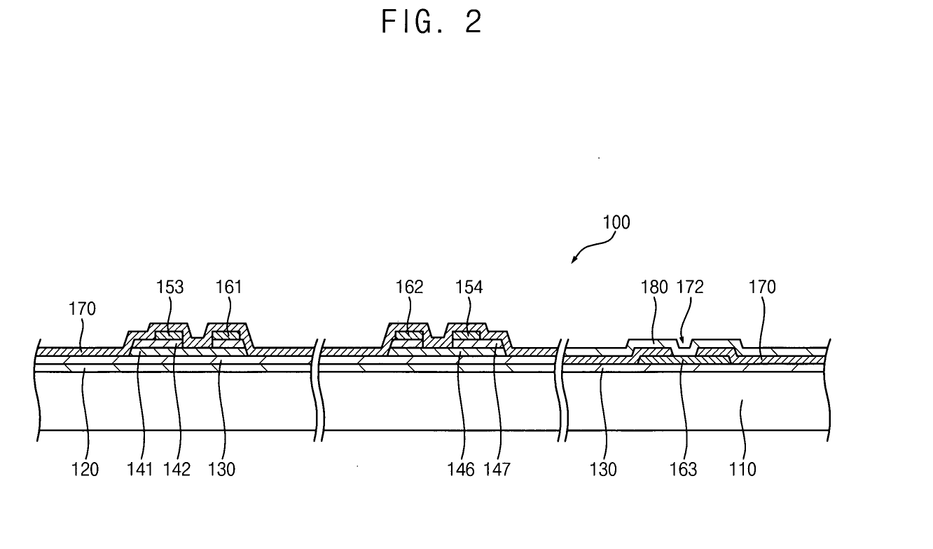

FIG. 1 is a layout illustrating a portion of a display substrate according to an exemplary embodiment of the present invention, and FIG. 2 is a cross-sectional view taken along a line I-I′ in FIG. 1.

Referring to FIGS. 1 and 2, a display substrate 100 according to an example of the present invention includes a plastic substrate 110, a gate wiring 120, a gate insulation layer 130, a first active layer 140, a second active layer 145, a data wiring 150 and a drain wiring 160.

The plastic substrate 110 has a thin-film shape that is flexible. The plastic substrate 110 may comprise a synthetic resin that is optically transparent.

The gate wiring 120 is formed on the plastic substrate 110. The gate wiring 120 includes a gate line 122 and a first gate electrode portion 124 and a second gate electrode portion 126. The first gate electrode portion 124 and the second gate electrode portion 126 are electrically connected to the gate line 122.

The gate wiring 122 extends along a first direction. The first gate electrode portion 124 is electrically connected to the gate line 122, and the first gate electrode portion 124 is an element of a first switching device TFT1. The second gate electrode portion 126 is electrically connected to the gate line 122, and the second gate electrode portion 126 is an element of a second switching device TFT2.

The gate insulation layer 130 is formed on the plastic substrate 110 having the gate wiring 120 formed thereon. The gate insulation layer 130 comprises, for example, silicon nitride (SiNₓ), silicon oxide (SiOₓ), etc.

A first active layer 140 and a second active layer 145 are formed on portions of the gate insulation layer 130, and the portions correspond to the first and second gate electrode portions 124 and 126, respectively.

The first active layer 140 includes a first semiconductor layer 141 and a first ohmic contact layer 142. The second active layer 145 includes a second semiconductor layer 146 and a second ohmic contact layer 147. The first and second semiconductor layers 141 and 146 comprise amorphous silicon (a-Si). The first and second ohmic contact layers 142 and 147 comprise amorphous silicon having n-type dopant (n⁺ a-Si).

The data wiring 150 is formed on the gate insulation layer 130 along a second direction that is substantially perpendicular to the first direction. The data wiring 150 includes a first data line 151 corresponding to the first gate electrode portion 124, and a second data line 152 corresponding to the second gate electrode portion 126. The first and second data lines 151 and 152 extend along the second direction so that the first and second data lines 151 and 152 are substantially perpendicular to the gate line 122 that extends along the first direction.

The first data line 151 includes a first source electrode portion 153 disposed on the first active layer 140. The first source electrode portion 153 is an element of the first switching device TFT1. The second data line 152 includes a second source electrode portion 154 disposed on the second active layer 145. The second source electrode portion 154 is an element of the second switching device TFT2.

The drain wiring 160 is formed on the gate insulation layer 130. The drain wiring 160 is disposed between the first and second data lines 151 and 152. The drain wiring 160 includes a first drain electrode portion 161 and a second drain electrode portion 162. The first drain electrode portion 161 is disposed on the first active layer 140, and the second drain electrode portion 162 is disposed on the second active layer 145.

The first drain electrode portion 161 is an element of the first switching device TFT1, and the second drain electrode portion 162 is an element of the second switching device TFT2.

The first source electrode portion 153 and the first drain electrode portion 161 are spaced apart from each other over the first active layer 140. The first active layer 140 corresponds to a channel of the first switching device TFT1. The second source electrode portion 154 and the second drain electrode portion 162 are spaced apart from each other over the second active layer 145. The second active layer 145 corresponds to a channel of the second switching device TFT2.

The drain wiring 160 further includes a contact portion 163 to which the first and second drain electrode portions 161 and 162 are electrically connected. The contact portion 163 is disposed between the first and second drain electrode portions 161 and 162.

The data wiring 150 and the drain electrode wiring 160 comprise substantially the same material. The data wiring 150 and the drain electrode wiring 160 are formed through the same process.

The display substrate 100 further includes a protection layer 170 and a pixel electrode 180. The protection layer 170 is formed on the gate insulation layer 130 having the data wiring 150 and the drain wiring 160 formed thereon. The protection layer 170 includes a contact hole 172 that exposes the contact portion 163 of the drain wiring 160.

The pixel electrode 180 is formed on the protection layer 170 such that the pixel electrode 180 overlaps with the contact portion 163 of the drain wiring 160. The pixel electrode 180 comprises an optically transparent and electrically conductive material. For example, the pixel electrode 180 may comprise indium tin oxide (ITO), indium zinc oxide (IZO), etc.

The pixel electrode 180 is electrically connected to the contact portion 163 of the drain wiring 160 through the contact hole 172.

Although not shown, the display substrate 100 optionally includes an organic layer (not shown) disposed between the protection layer 170 and the pixel electrode 180 in order to planarize a surface of the display substrate 100.

The display substrate 100 in accordance with the present invention employs a flexible plastic substrate 110. The plastic substrate 110 may be readily deformed by heat applied thereto during processes of forming the signal wiring and the switching devices. In particular, the plastic substrate 110 contracts after an etching process for forming the first and second active layers 140 and 145. Due to the contraction, the amount of misalignment at an edge portion of the substrate 110 is greater than the amount of misalignment at a center portion. Since the switching devices formed on the center portion of the plastic substrate 110 cannot overlap with the active layer, the source electrode, or drain electrode due to the misalignment, a channel of a switching device disposed at edge portions may be opened.

In order to prevent opening of a channel of a switching device, the display substrate 100 in accordance with the present invention includes two data lines 151 and 152, and two switching devices TFT1 and TFT2 per pixel electrode 180.

Additionally, the first active layer 140 is formed such that a distance between a center of the first active layer 140 and the first source electrode portion 153 is less than a distance between the center of the first active layer 140 and the first drain electrode portion 161. In addition, the second active layer 145 is formed such that a distance between a center of the second active layer 145 and the second source electrode portion 154 is less than a distance between the center of the second active layer 144 and the second drain electrode portion 162.

In detail, the first source electrode portion 153 and the first drain electrode portion 161 are substantially parallel in a region corresponding to the first active layer 140, and the second source electrode portion 154 and the second drain electrode portion 162 are substantially parallel in a region corresponding to the second active layer 145. The first active layer 140 disposed at a left side of the pixel electrode 180 (as shown in FIG. 1) is disposed such that the center of the first active layer 140 is disposed to the left of a center line between the first source electrode portion 153 and the first drain electrode portion 161.

The second active layer 145 disposed at a right side of the pixel electrode 180 is disposed such that the center of the second active layer 145 is disposed to the right of a center line between the second source electrode portion 154 and the second drain electrode portion 162.

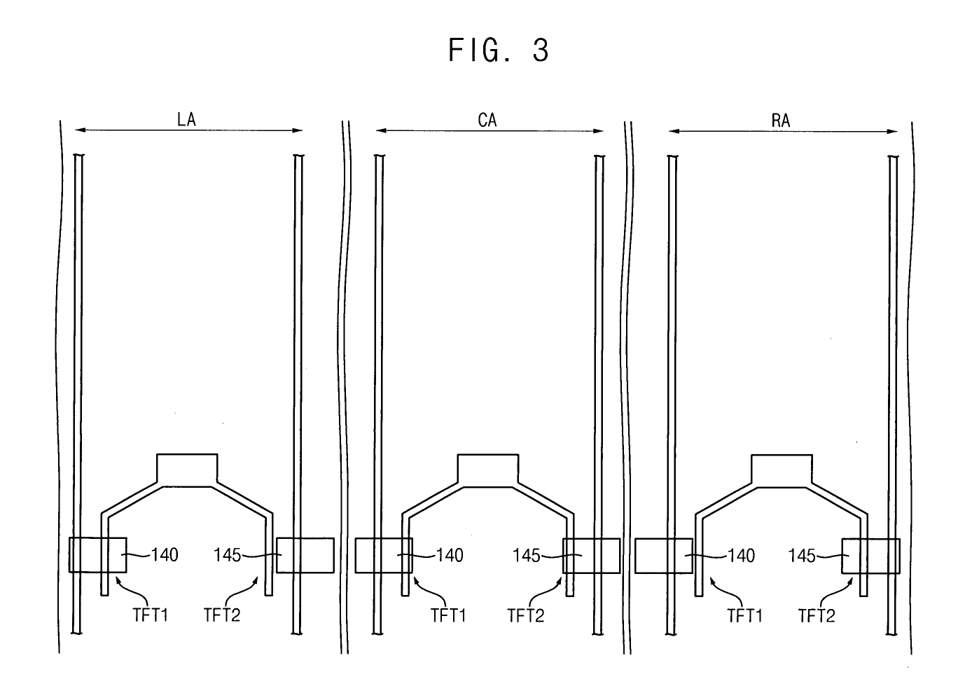

FIG. 3 is a layout illustrating a portion of a display substrate that is contracted.

Referring to FIG. 3, a center portion CA of the display substrate 100 contracts by a relatively small amount, so that channel layers of the first and second switching devices TFT1 and TFT2 are not opened. As a result, both of the first and second switching devices TFT1 and TFT2 operate normally.

A left portion LA of the display substrate 100 is contracts in a rightward direction by a relatively large amount, so that the first and second active layers 140 and 145 move rightward.

The first active layer 140 is formed such that a center of the first active layer 140 is disposed to the left of a center line between the first source electrode portion 153 and the first drain electrode portion 161. Therefore, even though the first active layer 140 moves rightward relative to the first source electrode portion 153 and the first drain electrode portion 161, the first active layer 140 remains overlapped with the first source electrode portion 153 and the first drain electrode portion 161. Thus, the first channel of the first switching device TFT1 is not opened. In contrast, the second active layer 145 is formed such that a center of the second active layer 145 is disposed to the right side of a center line between the second source electrode portion 154 and the second drain electrode portion 162. Therefore, when the second active layer 145 moves rightward, the second active layer 145 is no longer overlapped with the second source electrode portion 154 and the second drain electrode portion 162. Thus, the channel layer of the second switching device TFT2 is opened.

As a result, in the left portion LA of the display substrate 100, only the first switching device TFT1 that is disposed at the left side of the pixel electrode (not shown) operates normally.

A right portion RA of the display substrate 100 is contracts in a leftward direction by a relatively large amount, so that the first and second active layers 140 and 145 move leftward.

The first active layer 140 is formed such that a center of the first active layer 140 is disposed to the left of a center line between the first source electrode portion 153 and the first drain electrode portion 161. Therefore, when the first active layer 140 moves leftward, the first active layer 140 no longer overlaps with the first source electrode portion 153 and the first drain electrode portion 161. Thus, the first channel of the first switching device TFT1 is opened. In contrast, the second active layer 145 is formed such that a center of the second active layer 145 is disposed to the right of a center line between the second source electrode portion 154 and the second drain electrode portion 162. Therefore, when the second active layer 145 moves leftward, the second active layer 145 remains overlapped with the second source electrode portion 154 and the second drain electrode portion 162. Thus, the channel layer of the second switching device TFT2 is not opened.

As a result, in the right portion RA of the display substrate 100, only the second switching device TFT2 that is disposed at the right side of the pixel electrode (not shown) operates normally.

As described above, when the plastic substrate 110 contracts, both of the first and second switching devices TFT1 and TFT2 in the center portion CA of the plastic substrate 110 operate normally. In addition, one of the first or second switching devices TFT1 and TFT2 in the left and right portions LA and RA of the plastic substrate 110 operates normally. Accordingly, at least one of the first and second switching devices TFT1 and TFT2 continues to operate normally, even when the plastic substrate 110 is contracted and the first and second active layers 140 and 145 are misaligned relative to the first and second source electrode portions 153-154, and the first and second drain electrode portions 161-162. Therefore, the likelihood of a pixel becoming inoperative due to open channel defects may be reduced.

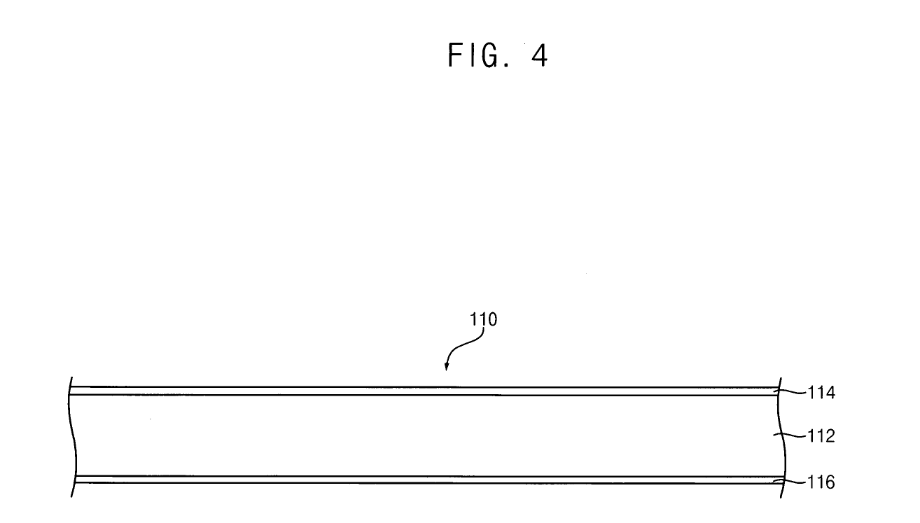

FIG. 4 is a cross-sectional view illustrating the plastic substrate in FIG. 2.

Referring to FIG. 4, the plastic substrate 110 includes a base substrate 112, a first barrier layer 114 and a second barrier layer 116. The first barrier layer 114 is formed on an upper face of the base substrate 112, and the second barrier layer 116 is formed on a lower face of the base substrate 112.

The base substrate 112 comprises a resin such as polyethersulfone (PES), polycarbonate (PC), polyimide (PI), polyacrylate (PA), polyethylene naphthelate (PEN), polyethylene terephehalate (PET), etc.

The first and second barrier layers 114 and 116 are formed on the upper and lower faces of the base substrate 112, respectively, in order to prevent moisture or gas from infiltrating to the base substrate 112 and diffusing into the base substrate 112. The first and second barrier layers 114 and 116 comprise, for example, acryl based resin.

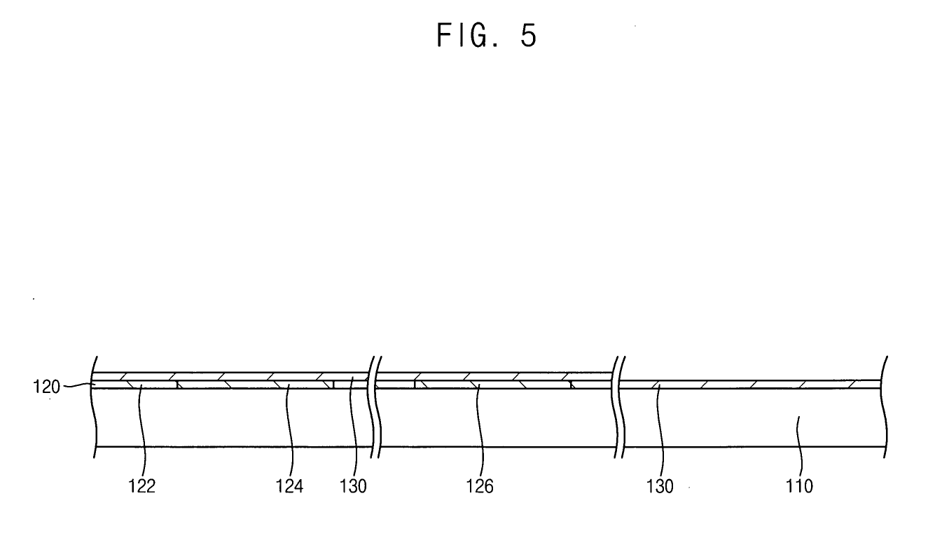

Hereinafter, a method of manufacturing display substrate according to the present invention will be described with reference to FIGS. 5 through 8.

FIGS. 5 through 8 are cross-sectional views illustrating a method of manufacturing the display substrate in FIGS. 1 and 2.

Referring to FIGS. 1 and 4, a first metal layer (not shown) is formed on the plastic substrate 110, and then the first metal layer is patterned to form the gate wiring 120 including the gate line 122, the first gate electrode portion 124 and the second gate electrode portion 126.

The gate wiring 120 extends along the first direction. The first and second gate electrode portions 124 and 126 are elements of the first and second switching devices TFT1 and TFT2, respectively.

The gate insulation layer 130 is formed on the plastic substrate 110 having the gate wiring 120 formed thereon. The gate insulation layer 130 comprises, for example, silicon nitride (SiNₓ) or silicon oxide (SiOₓ).

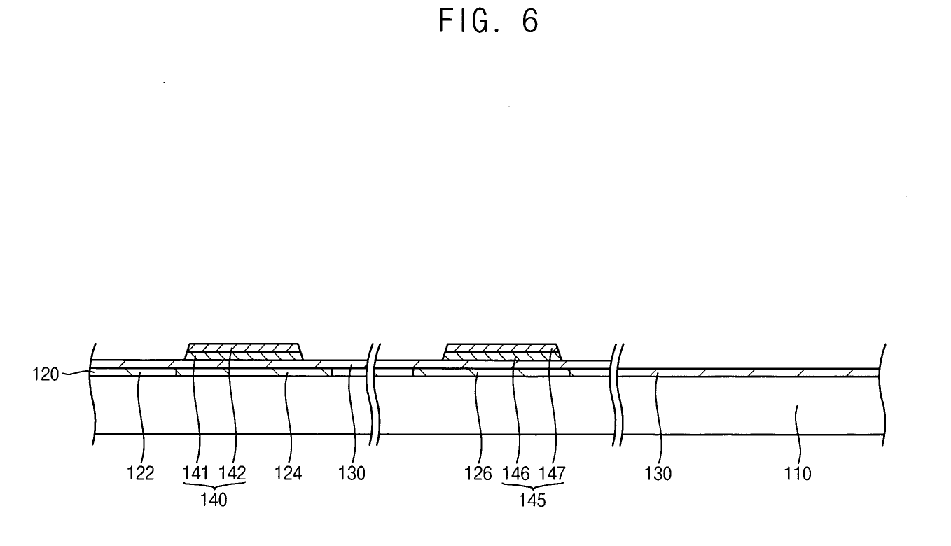

Referring to FIGS. 1 and 6, an a-Si layer for forming the semiconductor layer is formed on the gate insulation layer 130, and n⁺ a-Si layer for forming the ohmic contact layer is formed on the a-Si layer. The a-Si layer and the n⁺ a-Si layer are patterned to form the first and second active layers 140 and 145 disposed over the first and second gate electrode portions 124 and 126, respectively.

The first active layer 140 includes the first semiconductor layer 141 and the first ohmic contact layer 145, and the second active layer 140 includes the second semiconductor layer 146 and the second ohmic contact layer 147.

The first and second semiconductor layers 141 and 146 comprise a-Si. The first and second ohmic contact layers 145 and 147 comprise n⁺ a-Si.

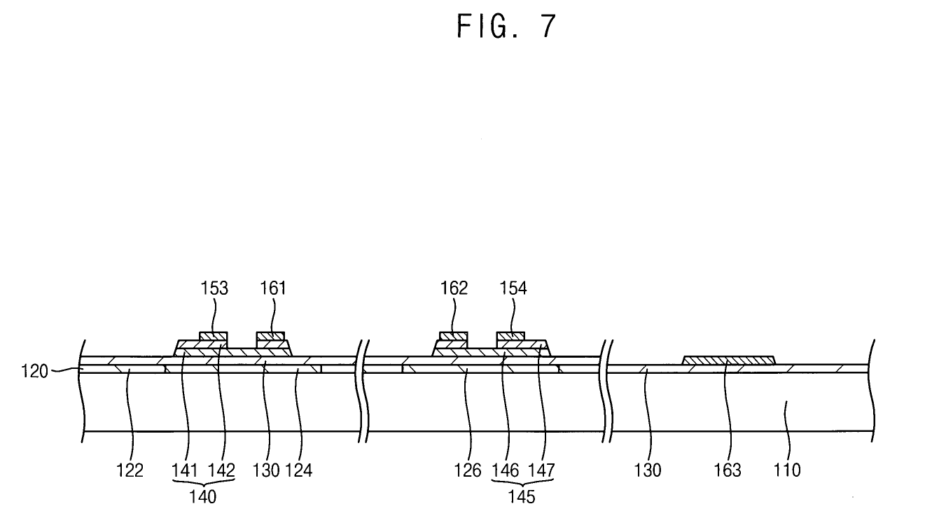

Referring to FIGS. 1 and 7, a second metal layer (not shown) is formed on the gate insulation layer 130, and the first and second active layers 140 and 145, the second metal layer are patterned to form the data wiring 150 and the drain wiring 160.

The data wiring 150 includes a first data line 151 and a second data line 152. The first data line 151 includes the first source electrode portion 153 disposed on the first active layer 140, and the second data line 152 includes the second source electrode portion 154 disposed on the second active layer 145.

The first and second data lines 151 and 152 extends along the second direction that is substantially perpendicular to the first direction. The first source electrode portion 153 is an element of the first switching device TFT1, and the second source electrode portion 154 is an element of the second switching device TFT2.

The drain wiring 160 includes the first drain electrode portion 161 disposed on the first active layer 140, the second drain electrode portion 162 disposed on the second active layer 145, and the contact portion 163 disposed on the gate insulation layer 130. The drain wiring 160 is disposed between the first and second data lines 151 and 152.

The first drain electrode portion 161 is an element of the first switching device TFT1, and the second drain electrode portion 162 is an element of the second switching device TFT2.

The first source electrode portion 153 and the first drain electrode portion 161 are spaced apart from each other. The first source electrode portion 153 and the first drain electrode portion 161 are disposed over the first active layer 140, such that a current may flow between the first source electrode portion 153 and the first drain electrode portion 161 through the first active layer 140. The second source electrode portion 154 and the second drain electrode portion 162 are spaced apart from each other. The second source electrode portion 154 and the second drain electrode portion 162 are disposed over the second active layer 145, such that a current may flow between the second source electrode portion 154 and the second drain electrode portion 162 through the second active layer 145.

The contact portion 163 is disposed between the first drain electrode portion 161 and the second drain electrode portion 162. The first drain electrode portion 161 and the second drain electrode portion 162 are electrically connected to the contact portion 163.

Then, the first ohmic contact layer 145 disposed between the first source electrode portion 153 and the first drain electrode portion 161, and the second ohmic contact layer 147 disposed between the second source electrode portion 154 and the second drain electrode portion 162 are removed to expose the first semiconductor layer 141 and the second semiconductor layer 146, respectively.

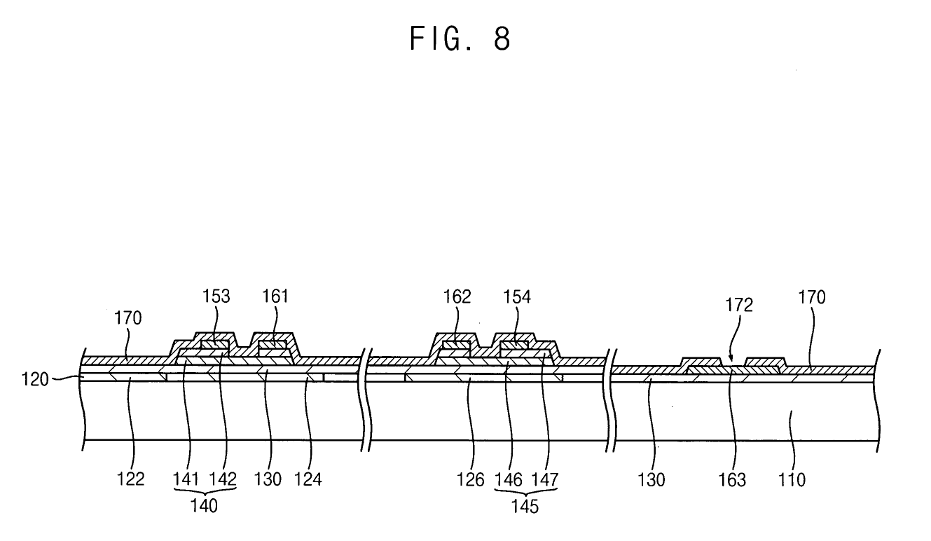

Referring to FIGS. 1 and 8, the protection layer 170 is formed on the gate insulation layer 130 having the data wiring 150 and the drain wiring 160 formed thereon. Then, a portion of the protection layer 170 is removed to form the contact hole 172 that exposes a portion of the contact portion 163 of the drain wiring 160.

Referring again to FIGS. 1 and 2, a transparent and conductive layer (not shown) is formed on the protection layer 170, and the transparent and conductive layer is patterned to form the pixel electrode 180. The pixel electrode 180 comprises an optically transparent and electrically conductive material. The pixel electrode 180 comprises, for example, indium tin oxide (ITO), indium zinc oxide (IZO), etc.

The pixel electrode 180 is electrically connected to the contact portion 163 of the drain wiring 160 through the contact hole 172 formed at the protection layer 170.

In accordance with the present invention, the first active layer 140 is formed such that a distance between a center of the first active layer 140 and the first source electrode portion 153 is less than a distance between the center of the first active layer 140 and the first drain electrode portion 161, and the second active layer 145 is formed such that a distance between a center of the second active layer 145 and the second source electrode portion 154 is less than a distance between the center of the second active layer 144 and the second drain electrode portion 162.

In detail, the first active layer 140 disposed at the left side of the pixel electrode 180 is disposed such that a center of the first active layer 140 is disposed to the left of a center line between the first source electrode portion 153 and the first drain electrode portion 161. The second active layer 145 disposed at the right side of the pixel electrode 180 is disposed such that a center of the second active layer 145 is disposed to the right of a center line between the second source electrode portion 154 and the second drain electrode portion 162.

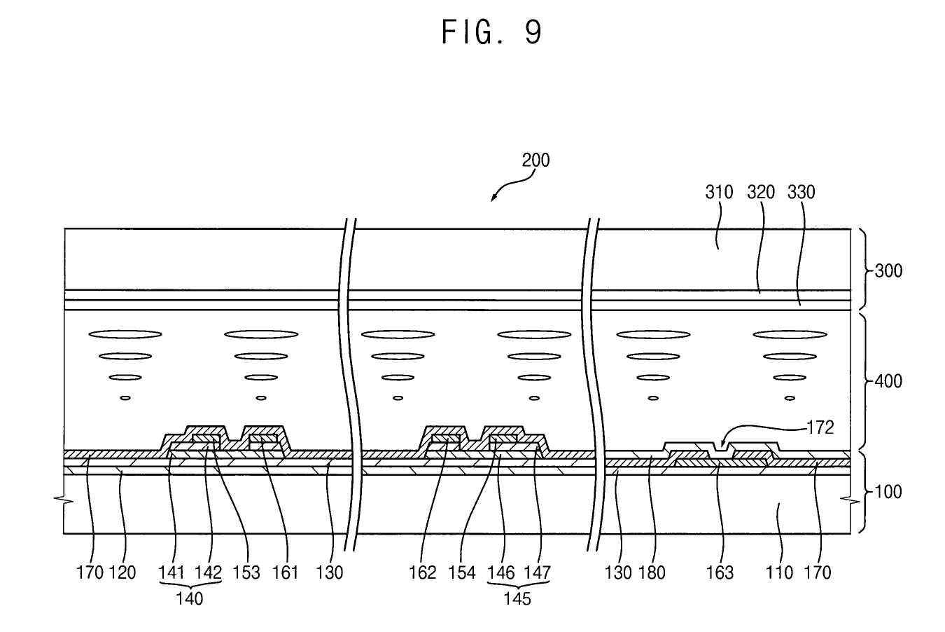

FIG. 9 is a cross-sectional view illustrating a display apparatus according to an exemplary embodiment of the present invention. The display substrate 100 of the present embodiment is the same as in FIG. 2. Thus, the same reference numerals will be used to refer to the same or like parts as those described in FIG. 2 and any further explanation concerning the above elements will be omitted.

Referring to FIG. 9, a display apparatus 200 according to an example of the present invention includes a display substrate 100, a color filter substrate 300 facing the display substrate 100, and a liquid crystal layer 400 disposed between the display substrate 100 and the color filter substrate 300.

The color filter substrate 300 includes a plastic substrate 310, a color filter layer 320 and a common electrode 330.

The plastic substrate 310 has a thin film shape that is flexible. The plastic substrate 310 comprises, e.g., an optically transparent resin. The plastic substrate 310 may comprise, for example, polyethersulfone (PES).

The color filter layer 320 is formed on a side of the plastic substrate 310 facing the display substrate 100. The color filter layer 320 includes a red color filter, a green color filter, and a blue color filter. Alternatively, the color filter layer 320 may be formed on the display substrate 100.

The common electrode 330 is formed on the color filter layer 320 such that the common electrode 330 faces the display substrate 100. The common electrode 330 comprises an optically transparent and electrically conductive material. The common electrode 330 comprises, for example, indium tin oxide (ITO), indium zinc oxide (IZO), etc.

The liquid crystal layer 400 includes liquid crystal molecules in a regular arrangement. The liquid crystal layer 400 has anisotropy of refractive index and dielectric coefficient. When electric fields are applied to the liquid crystal layer 400, an arrangement of the liquid crystal layer 400 is altered to control optical transmittance through the liquid crystal layer 400.

According to the display substrate, the method of manufacturing the display substrate, and the display apparatus having the display substrate, each pixel includes two data lines and two switching devices. The two switching devices are formed such that the first active layer disposed at the left side of the pixel electrode is disposed such that a center of the first active layer is disposed to the left of a center line between the first source electrode portion and the first drain electrode portion. The second active layer disposed at the right side of the pixel electrode is disposed such that a center of the second active layer is disposed to the right of a center line between the second source electrode portion and the second drain electrode portion.

Therefore, even when the display substrate contracts, at least one of the two switching devices continues to operate normally, thereby reducing the occurrence of defective pixels caused by misalignment.

Having described the exemplary embodiments of the present invention and their advantages, it is noted that various changes, substitutions, and alterations can be made herein without departing from the spirit and scope of the invention as defined by appended claims.

What is claimed is:

1. A display substrate comprising:
a plastic substrate;
a gate insulation layer formed on the plastic substrate, said gate insulation layer comprising first and second portions;
a gate wiring formed between the plastic substrate and the gate insulation layer along a first direction, the gate wiring comprising a gate line, a first gate electrode portion, and a second gate electrode portion, said first gate electrode portion aligned with the first portion of the gate insulation layer and said second gate electrode portion aligned with the second portion of the gate insulation layer;
first and second active layers formed on the first and second portions of the gate insulation layer;
a data wiring formed on the gate insulation layer along a second direction nonparallel with the first direction, the data wiring comprising a first data line having a first source electrode portion formed on the first active layer, and a second data line having a second source electrode portion formed on the second active layer; and
a drain wiring disposed between the first data line and the second data line, the drain wiring comprising a first drain electrode portion formed on the first active layer, and a second drain wiring comprising a second drain electrode portion formed on the second active layer.

2. The display substrate of claim 1, wherein the first active layer is formed such that a distance between a center of the first active layer and the first source electrode portion is less than a distance between the center of the first active layer and the first drain electrode portion.

3. The display substrate of claim 1, wherein the second active layer is formed such that a distance between a center of the second active layer and the second source electrode portion is less than a distance between the center of the second active layer and the second drain electrode portion.

4. The display substrate of claim 1, further comprising:
a protection layer formed on the gate insulation layer having the data wiring and the drain wiring formed thereon; and
a pixel electrode formed on the protection layer.

5. The display substrate of claim 4, wherein the drain wiring further comprises a contact portion electrically connected to the first and second drain electrode portions.

6. The display substrate of claim 5, wherein the contact portion is disposed between the first and second drain electrode portions.

7. The display substrate of claim 5, wherein the pixel electrode is electrically connected to the contact portion through a contact hole formed in the protection layer.

8. The display substrate of claim 1, wherein the plastic substrate comprises:
a base substrate;
a first barrier layer formed on an upper face of the base substrate; and
a second barrier layer formed on a lower face of the base substrate.

9. The display substrate of claim 8, wherein the base substrate comprises any one selected from the group consisting of polyethersulfone (PES), polycarbonate (PC), polyimide (PI), polyacrylate (PA), polyethylene naphthelate (PEN) and polyethylene terephehalate (PET).

10. The display substrate of claim 8, wherein the first and second barrier layers comprise an acryl based resin.

11. The display substrate of claim 1, wherein the first and second active layers comprise:
a semiconductor layer comprising amorphous silicon; and
an ohmic contact layer formed on the semiconductor layer, the ohmic contact layer comprising amorphous silicon having n-type dopant.

12. A method of manufacturing a display substrate, comprising:
forming a gate wiring on a plastic substrate, the gate wiring including a gate line, a first gate electrode portion, and a second electrode portion;
forming a gate insulation layer on the plastic substrate having the gate wiring formed thereon;
forming first and second active layers on first and second portions of the gate insulation layer, the first and second portions of the insulation layer corresponding to the first and second gate electrode portions, respectively;
forming a data wiring on the gate insulation layer along a second direction nonparallel with the first direction, the data wiring comprising a first data line having a first source electrode portion formed on the first active layer, and a second data line having a second source electrode portion formed on the second active layer; and
forming a drain wiring between the first data line and the second data line, the drain wiring comprising a first drain electrode portion formed on the first active layer, and a second drain electrode portion formed on the second active layer.

13. The method of claim 12, wherein the first active layer is formed such that a distance between a center of the first active layer and the first source electrode portion is less than a distance between the center of the first active layer and the first drain electrode portion, and the second active layer is formed such that a distance between a center of the second active layer and the second source electrode portion is less than a distance between the center of the second active layer and the second drain electrode portion.

14. The method of claim 13, further comprising:
forming a protection layer on the gate insulation layer having the data wiring and the drain wiring formed thereon; and
forming a pixel electrode on the protection layer.

15. The method of claim 14, wherein the drain wiring further comprises a contact portion electrically connected to the first and second drain electrode portions.

16. The method of claim 15, wherein the pixel electrode is electrically connected to the contact portion through a contact hole formed in the protection layer.

17. The method of claim 12, wherein the data wiring and the drain wiring are formed from a single metal layer.

18. A display apparatus comprising:
a first substrate;
a second substrate facing the first substrate; and
a liquid crystal layer disposed between the first and second substrate, wherein the first substrate including:
a first plastic substrate;
a gate insulation layer formed on the first plastic substrate, said gate insulation layer comprising first and second portions;
a gate wiring formed between the plastic substrate and the gate insulation layer along a first direction, the gate wiring comprising a gate line, a first gate electrode portion, and a second gate electrode portion, said first gate electrode portion aligned with the first portion of the gate insulation layer and said second gate electrode portion aligned with the second portion of the gate insulation layer;
first and second active layers formed on first and second portions of the gate insulation layer;
a data wiring formed on the gate insulation layer along a second direction nonparallel with the first direction, the data wiring comprising a first data line having a first source electrode portion formed on the first active layer, and a second data line having a second source electrode portion formed on the second active layer; and
a drain wiring disposed between the first data line and the second data line, the drain wiring comprising a first drain electrode portion formed on the first active layer, and a second drain wiring comprising a second drain electrode portion formed on the second active layer.

19. The display apparatus of claim 18, wherein the first active layer is formed such that a distance between a center of the first active layer and the first source electrode portion is less than a distance between the center of the first active layer and the first drain electrode portion, and the second active layer is formed such that a distance between a center of the second active layer and the second source electrode portion is less than a distance between the center of the second active layer and the second drain electrode portion.

20. The display apparatus of claim 19, further comprising:
a protection layer formed on the gate insulation layer having the data wiring and the drain wiring formed thereon; and
a pixel electrode formed on the protection layer.

21. The display apparatus of claim 20, wherein the drain wiring further comprises a contact portion electrically connected to the first and second drain electrode portions, and the pixel electrode is electrically connected to the contact portion through a contact hole formed at the protection layer.

22. The display apparatus of claim 20, wherein the second substrate comprises:
a second plastic substrate; and
a common electrode formed on the second plastic substrate such that the common electrode faces the pixel electrode.
